(19) United States
(12) Patent Application Publication
(10) Pub. No.: US 2025/0303485 A1
(43) Pub. Date: Oct. 2, 2025

(54) SUCTION DEVICE AND HANDHELD POWER SAW MACHINE EQUIPPED THEREWITH

(71) Applicant: Festool GmbH, Wendlingen (DE)

(72) Inventor: Andreas König, Leinfelden-Echterdingen (DE)

(21) Appl. No.: 19/236,083

(22) Filed: Jun. 12, 2025

Related U.S. Application Data
(62) Division of application No. 17/916,867, filed on Oct. 4, 2022.

(30) Foreign Application Priority Data
Oct. 28, 2020 (DE) 10 2020 128 371.7
Dec. 4, 2020 (DE) 10 2020 132 285.2

(51) Int. Cl. B23D 59/00; B23D 49/16

(52) U.S. Cl. CPC B23D 59/006; B23D 49/162

(57) ABSTRACT

A portable handheld reciprocating saber saw having a suction device, wherein: the handheld saber saw has a housing (17) in which a drive motor (11) is arranged and has a tool holder (14), which can be driven to linearly oscillate along an axis of movement (SO) by the drive motor (11), for a sawing tool (15) having an elongate design and extending along a longitudinal axis for making a saw cut in a workpiece (W). The suction device (30) has at least one guide contour (55) which, when the suction device is mounted on the handheld reciprocating saber saw, protrudes in front of the machine guide surface (23) such that the handheld reciprocating saber saw can be guided on the workpiece by means of the at least one guide contour (55) instead of the machine guide surface.

### CROSS-REFERENCE TO RELATED APPLICATIONS

This application is divisional of U.S. patent application Ser. No. 17/916,867, filed Oct. 4, 2022 which is a National Stage application based on an International Application filed under the Patent Cooperation Treaty, National Stage application based on International Application No. PCT/EP2021/077412, filed Oct. 5, 2021, which claims priority to DE 102020128371.7, filed Oct. 28, 2020 and DE 102020132285,2, filed Dec. 4, 2020.

### BACKGROUND OF THE INVENTION

The invention relates to a suction device for a portable handheld power saw, wherein the handheld power saw has a housing in which a drive motor is arranged and has a tool holder, which can be driven to linearly oscillate along an axis of movement by the drive motor, for a sawing tool having an elongate design and extending along a longitudinal axis for making a saw cut in a workpiece, wherein the handheld power saw has a machine guide body having a machine guide surface facing away from the housing, in front of which machine guide surface the sawing tool protrudes when mounted on the handheld power saw, for guiding the handheld power saw on the workpiece, wherein the suction device has fastening means for detachable fastening on the handheld power saw and has a suction connection for connecting a suction hose such that particles produced when the workpiece is being machined can be suctioned away from the machine guide body through the suction connection. The invention also relates to a handheld power saw with such a suction device.

Such a suction device and a handheld power saw equipped therewith are described, for example, in DE 10 2018 102 855 A1. The known suction device is fastened, for example, to the housing, such that when sawing into the workpiece, for example insulating material, the particles produced can be suctioned away directly through the suction connection. The particles pass through the machine guide body in the direction of the suction device.

The known suction device is preferably permanently fastened to the housing, even if it is in principle removable therefrom.

Further suction devices are described in EP 3 715 032 A1, US 2013/0055577 A1, EP 0 347 631 A2, DE 10 2013 226 082 A1, EP 2 567 964 A1 and US 2011/0083330 A1.

### SUMMARY OF THE INVENTION

It is therefore the object of the present invention to provide an improved suction device and a handheld power saw equipped therewith.

To achieve the object, a suction device of the type mentioned at the outset provides for the suction device to have at least one guide contour which, when the suction device is mounted on the handheld power saw, protrudes in front of the machine guide surface, such that the handheld power saw can be guided on the workpiece using the at least one guide contour instead of the machine guide surface. To achieve the object, a handheld power saw with such a suction device is also provided.

An advantage results, for example, from the fact that the guide contour is optimally adapted to the respective guide task. For example, different suction devices can be provided for different guide tasks. If the guide contour is worn out, it can be easily replaced, for example by replacing the entire suction device. Furthermore, the assembly and disassembly of the suction device is facilitated. The suction device can be fastened to the front of the machine guide body or mounted in another way. The suction device does not have to be placed, for example, in an intermediate space between the machine guide body and the housing.

Furthermore, the assembly of the suction device is facilitated by the fact that it is not or at least not completely to be mounted behind the machine guide surface, e.g., in a space between the machine housing and the machine guide body, but can be mounted completely or at least partially in front of the machine guide surface.

It is advantageous if a suction channel or flow channel of the suction device, which is connected on the one hand to the suction connection and on the other hand to a location at which the sawing tool is arranged when the suction device is mounted on the handheld power saw, runs next to or on the machine guide surface. This can contribute to improved suction.

An advantageous measure provides that the suction device has a flow channel that extends between a receiving region for the sawing tool and the suction connection, the flow channel extending along the machine guide surface and/or on a side of the machine guide body facing away from the housing when the suction device is fastened to the handheld power saw.

The suction device can be designed, for example, in the manner of a shoe.

The machine guide body is designed, for example, as a type of slide for guiding along the workpiece or a workpiece surface of the workpiece.

The machine guide surface and/or the guide contour of the suction device is, for example, a sliding surface or includes a sliding surface. The machine guide surface and/or the guide contour is or preferably includes a planar surface or planar surface.

The machine guide surface and/or the suction device can, for example, have a recess, in particular a fork-shaped and/or V-shaped or U-shaped recess in which the sawing tool is received and/or which is intended to hold the sawing tool.

The machine guide surface extends, for example, transversely to the axis of movement of the tool holder and/or transverse to the longitudinal axis of the sawing tool.

It is advantageously provided that the suction device, in particular the at least one guide contour, at least partially covers or only partially covers the machine guide surface. It is therefore possible for the machine guide surface to be completely or partially covered by the suction device.

Provision can be made, for example, for a partial portion of the machine guide surface to protrude in front of the suction device, in particular laterally and/or in particular in front of the at least one guide contour when the suction device is mounted on the handheld power saw. This portion of the machine guide surface is, for example, positioned at the back in the working direction and is not needed, for example, for guiding the handheld power saw on the workpiece. The partial portion of the machine guide surface protrudes in front of the suction device, for example on a side opposite to the suction connection.

Provision is also advantageously made for the at least one guide contour to protrude in front of the machine guide body, in particular on a side facing the suction connection.

The suction device advantageously has a support portion for support on the machine guide surface. The support portion includes, for example, support surfaces which are opposite the machine guide surface and which are provided and/or are designed for supporting the machine guide surface. The support surfaces are, for example, planar surfaces or have planar surface portions.

The suction connection is preferably arranged next to the support part. For example, the suction connection can be arranged at the back in the working direction when the suction device is fastened to the handheld power saw. As a result, for example, the operator's view of a work location or of a point where the sawing tool cuts into the workpiece is not impaired by the suction connection or a suction hose arranged thereon.

The suction device is preferably designed in such a way that the suction connection is oriented in the direction of an underside of the housing of the handheld power saw when the suction device is fastened to the handheld power saw.

The suction device preferably has a recess for the sawing tool, for example a U-shaped, V-shaped recess, a slot or the like.

The suction connection and the recess for the sawing tool are preferably arranged on opposite end regions or longitudinal end regions of the suction device.

The guide contour of the suction device advantageously extends over the region of the support portion.

The guide contour advantageously extends into the region of the suction connection and/or over the entire region of the suction connection.

The guide contour preferably extends over an entire region of the suction device that faces away from the housing of the handheld power saw when the latter is mounted on the handheld power saw.

The support portion is preferably designed to receive part of the machine guide surface in such a way that another part of the machine guide surface projects in front of the suction device. A length of the support part with respect to a working direction, along which saw cuts can be made in a workpiece with the handheld power saw, is preferably shorter than a length of the machine guide surface with respect to this working direction.

The tool holder of the handheld power saw is preferably arranged between the housing and the machine guide body. The tool holder is preferably provided in a receiving space or intermediate space between the machine guide body and the housing that is freely accessible for a tool change of the sawing tool.

It is advantageous if the suction device does not extend into the or an intermediate space or receiving space between the machine guide body and the housing and/or does not reach into this space or receiving space when the suction device is mounted on the handheld power saw.

An expedient measure also provides that the suction device, apart from a part that receives the machine guide body in a form-fitting manner, does not engage in the or an intermediate space or receiving space between the machine guide body and the housing.

It is advantageously provided that the fastening means of the suction device are provided and/or are designed exclusively for fastening to the machine guide body. The fastening means therefore only comprise components which are intended for fastening to the machine guide body.

The suction device advantageously has no fastening means for fastening to the housing of the handheld power saw and/or no part that engages in a gap between the machine guide body and the housing when the suction device is mounted on the handheld power saw.

The fastening means advantageously have form-fitting holding means, in particular at least one form-fitting projection and/or at least one form-fitting receptacle for a form-fitting hold on the machine guide body. The fastening means particularly preferably have at least one form-fitting projection for form-fitting engagement in the machine guide body, in particular a plug-in receptacle of the machine guide body, and/or a form-fitting receptacle for a form-fitting reception of the machine guide body, in particular a plug-in projection of the machine guide body.

The fastening means advantageously have latching means for latching the suction device to the machine guide body. The latching means can include, for example, latching receptacles, latching hooks, latching projections or the like.

Alternatively or in addition to the latching means, however, magnetic holding means can also be provided, i.e., for example a magnet or the like, which is provided on the suction device and enables magnetic hold on the machine guide body of the handheld power saw.

It is preferred if the form-fitting holding means and/or the latching means and/or the magnetic holding means are arranged on a support part of the suction device on which the machine guide surface of the machine guide body is or can be supported. The form-fitting holding means and/or the latching means and/or the magnetic holding means are therefore used to hold directly on the machine guide surface. For example, a form-fit counter-contour for the form-fitting holding means is provided and designed directly on the machine guide surface, for example as a depression, a projection or the like on the machine guide surface. For example, the machine guide surface itself or a latching counter-contour arranged on the machine guide surface can be used for latching the latching means and/or be provided to magnetically hold the magnetic holding means. Said latching means or holding means therefore do not act on an edge region of the machine guide surface, but rather in a core region of the machine guide surface. For example, latching receptacles or plug-in receptacles are provided on the machine guide surface.

It is advantageous if the fastening means have at least one plug-in receptacle for plugging in the machine guide body and/or at least one plug-in projection for plugging into a machine plug-in receptacle along a plug-in path and/or have a quick-release axle. The support portion already mentioned is preferably provided in the region of the at least one plug-in receptacle and/or extends next to the receptacle. At least part of the machine guide surface can preferably be inserted into the plug-in receptacle.

The suction device advantageously has first and second plug-in receptacles arranged next to one another, into which the machine guide body can be inserted sequentially, i.e., it can first be plugged into the first and then into the second plug-in receptacle, with the machine guide body being already able to engage at least partially in the second plug-in receptacle when inserted into the first plug-in receptacle. When the machine guide body is fully inserted into the first plug-in receptacle, it can be fully inserted into the second plug-in receptacle.

A combination of both measures is easily possible. For example, a portion of the machine guide body can be inserted into the plug-in receptacle of the fastening means or the suction device, thus forming a guide-body plug-in projection, so to speak. The suction device for its part can have at least one plug-in projection, which can be plugged into a plug-in receptacle of the machine, for example when the machine guide body is plugged into the receptacle for the suction device. The at least one machine plug-in receptacle is preferably arranged on the machine guide surface. It is particularly advantageous if a machine plug-in receptacle is provided next to a recess for the sawing tool.

It is also advantageous if the plug-in receptacle of the suction device is designed to receive an edge part of the machine guide body, the edge part having a part of the machine guide surface and an end face of the machine guide body at an angle to the machine guide surface. For example, a part of the machine guide body that faces away from the tool holder of the handheld power saw can be provided for plugging into the plug-in receptacle of the suction device.

The plug-in receptacle of the suction device is preferably designed in the manner of a receptacle pocket. For example, the edge portion of the machine guide body can be inserted into these receiving parts.

The machine guide body therefore preferably has at least one machine plug-in receptacle, for example in the form of an eyelet, a slot or the like. As mentioned, this machine plug-in receptacle is preferably located on the machine guide surface, in particular next to a recess for the sawing tool.

A preferred measure provides for the fastening means to have plug-in fixing means for fixing the suction device transversely to the plug-in direction, along which the machine guide body can be plugged into the plug-in receptacle. The machine guide body is thus fixed in the plug-in receptacle by preventing it being pulled out by the plug-in fixing means.

The plug-in fixing means include, for example, magnetic holding means, in particular at least one magnet, and/or latching means and/or latch hooks and/or the already mentioned form-fitting holding means or the like.

The plug-in fixing means can be formed, for example, by a further plug-in projection or a further plug-in receptacle of the suction device:

It is advantageously possible, for example, for the machine guide body to be able to be inserted into the plug-in receptacle of the suction device along a first plug-in path, e.g., along a plug-in axis or direction and the at least one plug-in projection of the suction device can be inserted into the machine plug-in receptacle in a second plug-in path or direction at an angle with respect to the first plug-in path or direction, e.g., along an arcuate path. For example, the machine guide body can first be inserted into the plug-in receptacle and then the at least one plug-in projection of the suction device can be brought into engagement with the machine plug-in receptacle along the second plug-in direction.

Preferably on the plug-in receptacle of the suction device and/or on the at least one plug-in projection of the suction device there are latching means for latching with the machine guide body. It is possible for the at least one plug-in projection of the suction device to be designed as a latching hook. The latching means can include, for example, latching receptacles, latching hooks, latching projections or the like.

A plug-in direction for plugging the machine guide body into the plug-in receptacle of the suction device preferably extends away from the at least one plug-in projection or transversely to the at least one plug-in projection of the suction device. Thus, for example, a part of the machine guide body dips into the plug-in receptacle when it is plugged into the plug-in receptacle of the suction device and then the at least one plug-in projection of the suction device can be plugged into the machine plug-in receptacle of the machine guide body.

The machine guide body preferably has one or more receptacles for the fastening means of the suction device on the machine guide surface. Such a receptacle is or includes, for example, a form-fitting receptacle and/or a plug-in receptacle and/or a latching receptacle. One or more such receptacles are preferably provided on each of the side legs of the machine guide body, which extend next to a recess for the sawing tool. For example, the machine guide surface has passage openings and/or cavities as receptacles for the fastening means and/or for form-fitting fastening of the suction device in the region of the machine guide surface.

The suction device preferably has a pair of plug-in projections and/or latching hooks. The plug-in projections or latching hooks preferably have the same or essentially the same distance from the plug-in receptacle of the suction device if a plug-in receptacle is provided.

The suction device advantageously has a pair of plug-in projections, in particular latching hooks, for insertion into machine plug-in receptacles of the machine guide body, which have at least one latching contour, in particular a hooked projection, for latching with the machine plug-in receptacles, wherein the latching contours of the plug-in projections can be brought out of engagement with counter-latching contours of the machine plug-in receptacles, for example their edge regions, by a movement of the plug-in projections toward or away from each other. Thus, for example, an operator can grasp the plug-in projections with two fingers and move them towards one another in order to release a latching with the machine plug-in receptacles and thus bring the plug-in projections out of engagement with the machine plug-in receptacles.

When the latching means engage or disengage, application of force to the suction device can lead to its deformation, which makes operation more difficult, for example. The following measure can help to make operation easier:

It is advantageously provided that the fastening means have a latching body, in particular a latching hook, for latching with the machine guide body and at least one support body, in particular a plug-in projection or a plug-in receptacle, for support and/or form-fitting fixing of the suction device on the machine guide body with respect to a release movement for releasing the latching body from a latching engagement with the machine guide body and/or with respect to a fixing movement of the latching body for latching the suction device with the machine guide body. The latching body has a latching contour, for example a hook projection, for latching with the machine guide body, which can be disengaged from the machine guide body by a release movement. The support body counteracts, for example, a deformation of a base body of the suction device when the latching body is actuated.

An advantageous measure provides that the latching body and the at least one support body are arranged directly next to one another and/or both are designed for joint engagement in a machine plug-in receptacle of the machine guide body. If the latching body and the support body are arranged directly next to one another, for example a plug-in projection and a latching hook, they can engage in one and the same machine plug-in receptacle or in separate machine plug-in receptacles. The machine guide body is equipped accordingly, i.e., it has a pair of plug-in receptacles arranged next to one another or a sufficiently large plug-in receptacle and/or an elongated hole for receiving the latching body and the support body of the fastening means of the suction device.

It is particularly preferred if the latching body is arranged between two support bodies, for example between two plug-in projections, at least one of which is used for form-fitting fixing and/or supporting during the release movement or fixing movement of the latching body. It is possible for the other support body to form, for example, a displacement safeguard that blocks or impedes removal of the machine guide body, in particular its edge portion, from the plug-in receptacle of the suction device.

The guide contour can, for example, be designed as a machine guide surface or have a machine guide surface.

The suction device preferably has a recess for the sawing tool. The recess can be provided, for example, on a machine guide surface of the guide contour designed as a planar surface.

However, a recess for the sawing tool is preferably delimited by one or more side walls of the suction device.

At this point it should be mentioned that the guide contour can be designed as a planar surface, for example, or can have a planar surface.

However, the guide contour is preferably relatively narrow, which can be implemented in particular by the following measures.

It is advantageous if the suction device has at least one side wall, the narrow side or face of which forms the guide contour or a part of the guide contour. It is advantageously provided that the at least one side wall is located next to the suction connection and/or extends in a region between the suction connection and a recess of the suction device for the sawing tool.

The sidewall may form part of a U-shaped or annular sidewall or be configured as a U-shaped or annular sidewall. The side wall can delimit a flow channel, for example, through which particles can flow away from the sawing tool in the direction of the suction connection.

A preferred measure provides that the guide contour has a U-shape. A base leg of the guide contour preferably runs next to the suction connection. Side legs of the guide contour advantageously extend in the direction of a recess for the sawing tool.

It is advantageously provided that the suction device has at least two side walls at a distance from one another, the distance being designed and provided for receiving the sawing tool or the saw blade and/or forming part of a flow channel leading to the suction connection. Narrow sides of the side walls are provided, for example, for resting on the workpiece or for guiding on the workpiece.

The suction device as a whole or a part thereof is preferably made of plastic, which is also preferably reinforced by fibers, for example glass fibers and/or carbon fibers. The suction device can thus be produced inexpensively and can therefore be easily replaced when it is worn. For example, the guide contour in this embodiment of the suction device is also made of plastic.

For example, the suction device consists at least partially or entirely of polycarbonate-acrylonitrile-butadiene-styrene copolymer (PC-ABS), polyoxymethylene (POM), polyamide, in particular polyamide with glass fiber reinforcement, for example PA6GFx, where x is a percentage of glass fibers and is, for example, between 5 and 50, in particular about 5-20. For example, the plastic consists of 5% of glass fibers when designated as PA6GF5.

Advantageously, however, only one base body of the suction device can be made of plastic, particularly in connection with the measure explained below.

An advantageous concept provides that at least part of the guide contour is arranged on a guide element which is detachably fastened or can be fastened to a base body of the suction device. The guide element is designed, for example, like a plate. For example, two guide elements can be provided, which are designed in the manner of skids.

It is also advantageous if the guide contour as a whole or at least part of the guide contour is arranged on a guide element which is detachably fastened or can be fastened to a base body of the suction device.

The suction connection has, for example, a connection body, in particular a tubular body.

For example, latching means, in particular latching lugs or the like, can be provided on the suction connection for latching or holding the suction hose in a form-fitting manner. The suction connection preferably comprises a tubular connection element or a tubular body.

This tubular body can form a connecting piece.

In a guide plane that is spanned by the guide contour or that is provided on the guide contour, the suction device is supported in the region of the sawing tool on the workpiece to be machined when the suction device is mounted on the handheld power saw. It goes without saying that other parts of the guide contour can, for example, be set back in relation to this guide plane, in particular parts of the guide contour in the region of the suction connection. The guide contour can preferably have a skid-like shape.

It is preferred if the suction connection has a connection body, in particular a connecting piece, which is designed for fastening a suction hose and is rotatably or pivotally mounted with respect to a base body provided and designed for connection to the machine guide body, about one or more axes of rotation or pivot axes using at least one pivot bearing or one pivot bearing assembly. The connecting piece is designed, for example, as a piece of pipe. For example, a pivot axis of such a pivot bearing preferably runs parallel to a guide plane in which the guide contour lies or which is spanned by the guide contour.

It is advantageous if a longitudinal axis of the suction connection, in particular of a connection body of the suction connection, runs inclined at an angle to a machine guide surface which is spanned by the guide contour or in which the guide contour is arranged. A longitudinal extension or longitudinal axis of the suction connection, in particular a connection body of the suction connection, is oriented, for example, at an angle to a machine guide surface or region in which the guide contour of the suction device is located. The angle between the longitudinal axis or longitudinal extent of the suction connection and the machine guide surface is in a range of approximately 15° to 80°, for example. An inclination of approx. 20-40° is preferred. However, it is also possible that, for example, the machine guide surface and the longitudinal axis or longitudinal extent of the suction connection have an angle of 90° or almost 90°, for example if a region of the suction device on which the suction connection is arranged is protruding sufficiently far to the side in front of the machine guide body and/or the housing. If the connection body or suction connection is stationary with respect to the guide contour, the aforesaid angle is unchangeable. If a pivot bearing is present, the angle can be adjustable, for example in an angle range of 15° to 60°. Such pivotable arrangement can be implemented, for example, with a rotary axis or pivot axis that runs parallel to the machine guide surface.

The sawing tool advantageously has a sword-like or blade-like shape.

Advantageously, the drive motor of the handheld power saw or a longitudinal axis of the drive motor extends parallel to a longitudinal axis of the sawing tool.

The housing of the handheld power saw advantageously has a pistol-like shape.

It is advantageously provided that the suction connection is arranged at the front in the working direction when the suction device is fastened to the handheld power saw. This embodiment is preferred in particular when the suction device is used in a jigsaw.

The handheld power saw is preferably a saber saw and/or not a jigsaw. In principle, however, the invention can also be used with a jigsaw.

It should be mentioned that the handheld power saw can preferably be used in a first working direction and in a second working direction opposite to the first working direction. For example, the sawing tool can have a sawing contour, toothing or the like on opposite sides, such that saw cuts can be made in a workpiece in opposite working directions. However, it is also possible for the sawing tool to have a sawing contour on only one side, in particular the longitudinal side, to be fastenable to the tool holder of the handheld power saw in a first angular position in order to make saw cuts in the workpiece in a first working direction and in a second angular position offset by 180° in order to make saw cuts in a second position in the workpiece.

### BRIEF DESCRIPTION OF THE DRAWINGS

Exemplary embodiments of the invention are explained below with reference to the drawing. In the figures:

FIG. 1 shows a perspective oblique view of a handheld power saw with a suction device and a vacuum cleaner,

FIG. 2 shows a perspective oblique view of a front part of the handheld power saw according to FIG. 1 with the suction device removed,

FIG. 3 shows the front part of the handheld power saw according to FIG. 1 and the suction device from the side,

FIG. 4 shows a perspective oblique view of the suction device,

FIG. 5 shows a section through a machine guide body of the handheld power saw and the suction device approximately along a section line A-A in FIG. 4, the suction device being partially pivoted away from the machine guide body, for example when the suction device is installed on or removed from the machine guide body,

FIG. 6 shows the view according to FIG. 5, with the suction device being connected to the machine guide body,

FIG. 7 shows another suction device according to the above figures with magnetic hold in a perspective diagonally from below,

FIG. 8 shows the suction device according to FIG. 7, but with the guide elements removed,

FIG. 9 shows a plan view of the suction device according to FIGS. 7, 8,

FIG. 10 shows a cross-sectional view through the arrangement according to FIG. 9, approximately along section line B-B in FIG. 9;

FIG. 11 shows another suction device, for example in a plan view corresponding to FIG. 9,

FIG. 12 shows a side view of the suction device according to FIG. 11,

FIG. 13 shows a section through the guide device according to FIG. 11, approximately along section line D-D;

FIG. 14 shows a section through the guide device according to FIG. 12, approximately along section line E-E.

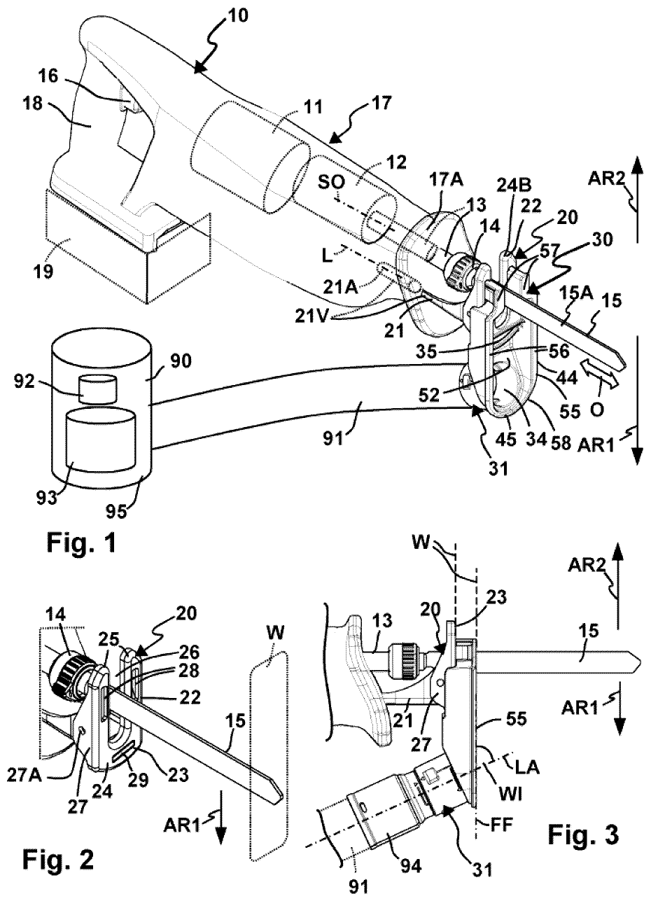

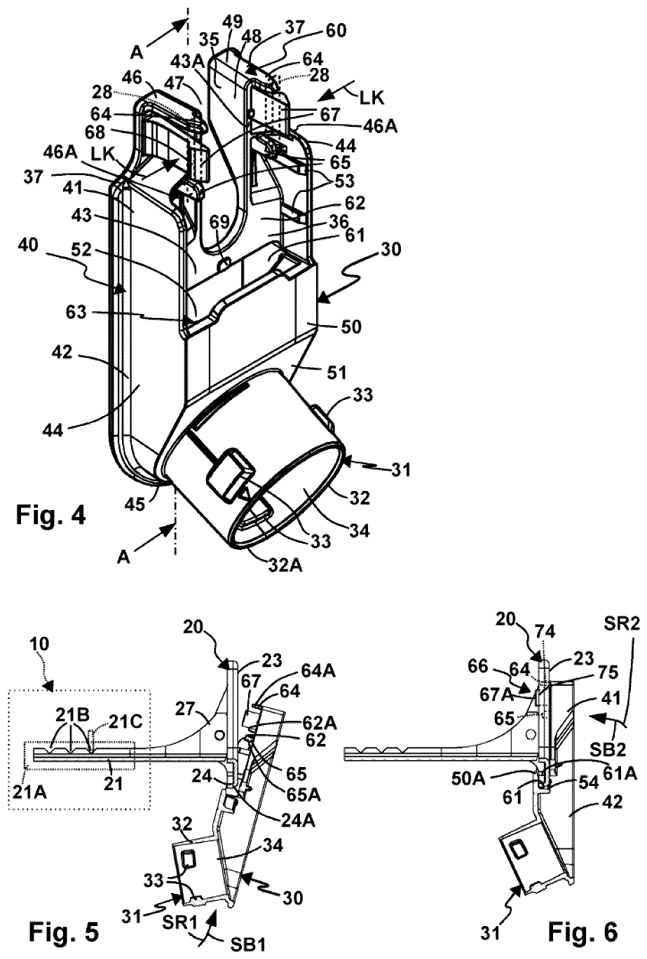

### DETAILED DESCRIPTION

In the exemplary embodiments described below, the same components are provided with the same reference symbols. Components that are essentially similar or functionally the same have reference numbers that differ by 100 in each case.

A handheld power saw 10 has a machine housing 17 in which a drive motor 11 is received. The drive motor 11 is, for example, an electric motor that can be supplied with electrical energy via an electrical energy store 19, for example a battery pack. Alternatively, the handheld power saw 10 may also comprise a mains cable in order to connect it to an electrical supply power supply.

The drive motor 11 can be switched on and off using a switching element 16 and can preferably also be adjusted with regard to its speed. The drive motor 11 drives an output element 13 via a gear 12, on which a tool holder 14 for a sawing tool 15 is provided. The sawing tool 15 is, for example, a saw blade 15a, which can be inserted into the tool holder 14 and locked therein.

The gear 12 is an oscillating gear and converts a rotating movement of the drive motor 11 into an oscillating linear movement, such that the tool holder 14 and thus also the sawing tool 15 makes an oscillating movement O along an axis of movement SO.

The sawing tool 15 can be fixed in opposite positions in the tool holder 14, such that the handheld power saw 10 can be operated once for a sawing operation in a working direction AR1 and in a position of the sawing tool 15 rotated by 180° with respect to the tool holder 14 in a working direction AR2.

Provided on a part of the machine housing 17 facing away from the tool holder 14 is a handle 18 which is designed like a pistol, such that the machine housing 17, which has a longitudinal shape, can be gripped by an operator. The switch 16, for example a pressure switch, is located on the handle 18.

The tool holder 14 is arranged on a front wall 17A of the machine housing 17, the front wall 17A and the handle 18 representing opposite end regions of the machine housing 17.

In order to guide the handheld power saw 10 on a workpiece, for example a wall surface or the like, the handheld power saw 10 has a machine guide device 20 with a machine guide body 22. The machine guide device 20 is positioned in front of the tool holder 14, so to speak, and has a machine guide surface 23 which extends in front of the machine tool holder 14 and is provided for guiding on a workpiece surface. The machine guide surface 23 is configured as a planar surface, for example.

The machine guide body 22 is mounted on the machine housing 17 such that it can be displaced with respect to a longitudinal axis L by means of a bearing device 21V. The bearing device 21V comprises support elements 21, which extend away from the machine guide body 22 in the direction of the machine housing 17 and are immovably received in displacement receptacles 21A arranged on the machine housing 17, in particular its inner space. In the region of the displacement receptacles 21A, there is a fixing body 21C, for example a bar, latching body or the like, for engaging in fixing receptacles 21B on one or both of the support elements 21 in order to fix the machine guide body 22 in different longitudinal positions with respect to the longitudinal axis L. A plurality of fixing receptacles 21B can be provided at longitudinal distances with respect to the longitudinal axis L.

The machine guide body 22 has side legs 27 which extend away from the machine guide surface 23 and/or are angled to the machine guide surface 23. The side legs 27 are connected to the supporting elements 21, for example integrally or connected by means of bolts or other connecting elements 27A.

The machine guide body 22 has an edge portion 24 from which side legs 25 extend away, between which there is a recess 26 for the sawing tool 15. The edge portion 24 could also be referred to as a base leg, from which side legs or guide legs 25 extend away. Overall, the edge portion 24 and the side legs 25 form a U-shape or a fork-like shape that delimits an intermediate space in the form of the recess 26 for the sawing tool 15. The machine guide surface 23 extends both in the region of the base leg or the edge portion 24 and on the side legs 25. Basically, the machine guide surface 23 is provided for guiding the handheld power saw 10 on the workpiece surface.

When the sawing tool 15 is in operation, chips, particles or the like are formed. These can be suctioned away by a suction device 90, for example a vacuum cleaner.

The suction device 90 has a suction housing 95, a suction turbine 92 and a dust collection chamber 93 which is flow-connected to a suction hose 91.

Now it can be easily imagined that it is difficult for the operator to bring the suction hose 91 or its inflow opening close to the work site of the sawing tool 15 and to hold it there during the sawing operation. In order to remedy this problem, a suction device 30 is provided which can be easily connected to the handheld power saw 10 when needed, but which can also be removed again just as easily when it is not needed.

The suction device 30 has a suction connection 31 for connecting the suction hose 91. The end of the suction hose 91 facing away from the suction housing 95 has a connecting piece 94 which can be connected to the suction connection 31. The connecting piece 94 can, for example, be plugged onto the suction connection 34 or inserted into the connection.

The suction connection 31 has a connecting piece 32 as a connection body 32A, for example a tubular body, which annularly encloses a passage channel 34. The passage channel 34 is flow-connected to a suction region 35 of the suction device 30, with the suction region 35 being arranged in the region of the sawing tool 15 or the tool holder 14 when the suction device 30 is fastened to the handheld power saw 10, such that when the sawing tool 15 is in operation, resulting chips or other similar particles can be sucked through the passage 34.

The connecting piece 94 can be inserted into the tubular body or connecting piece 32 or slipped onto it.

Form-fitting contours 33, for example latching projections, lugs or the like, are present on the connecting piece 32 for form-fittingly holding the connecting piece 94, such that this can be form-fittingly connected to the connecting piece 32 with a rotational plug-in movement, for example.

Form-fitting contours 33 which protrude into the passage channel 34 and are provided for a form-fitting engagement in the connecting piece 94 when this is inserted into the connecting piece 32 are advantageous.

Alternatively or additionally, however, form-fitting contours 33 can also be provided on an outside of the connecting piece 32 facing away from the passage channel 34, which contours are intended to engage in a connecting piece 94 plugged onto the connecting piece 32.

The suction device 30 has a base body 40.

The suction device 30 and/or the base body 40 comprise a support part 41 for support on the machine guide body 22 and a suction part 42 on which the suction connection 31 is provided. If the suction device 30 is fastened to the machine guide device 20, in particular the machine guide body 22, the suction portion 42 projects laterally in front of the machine guide body 22 at least partially.

The base body 40 has side walls 44 which are connected to one another by a bottom wall 43 at one longitudinal end region and by a rear wall 45 at another longitudinal end region. The side walls 44 and the rear wall 45 are integral with each other. The rear wall 45 is curved, for example, and extends next to the connecting piece 32 or its peripheral wall.

Arranged on their longitudinal end regions of the side walls 44 facing away from the rear wall 45 are supporting legs 46 which are provided for support and fastening to the machine guide body 22.

In the region of the support legs 46 or on the support legs 46 there is a recess 46A through which a portion of the machine guide body 22 protrudes laterally in front of the suction device 30.

Supporting contours 43A are provided on the support legs 46, which are flush with the bottom wall 43 and support the machine guide body 22, for example on the machine guide surface 23.

A recess 47 is provided on the bottom wall 43 and between the support legs 46 and the sawing tool 15 engages in this recess when the suction device 30 is fastened to the machine guide body 22.

The bottom wall 43 forms part of a base leg or a base 36 of the suction device 30, from which the side legs 37, namely in particular the support legs 46, protrude. The support legs 46 or side legs 37 are assigned to the side legs 27 of the machine guide body 22.

The side legs 37 and the base 36 essentially cover the machine guide surface 23 of the machine guide body 22.

A portion of the side legs 27 protrudes from the free end portions of the support legs 46 or side legs 37 but is not intended to be in contact with a workpiece. Rather, when the suction device 30 is mounted on the handheld power saw 10, a guide contour 55 of the suction device 30 is provided for guiding along a workpiece W.

The guide contour 55 has longitudinal portions 56 which are provided by the narrow sides of the side walls 44. The longitudinal portions 56 extend along the side legs 37 of the machine guide body 22 and/or of the suction device 30. Toward the free end regions of the side legs 27, the guide contour 55 also has support portions 57. The support portions 57 and a connecting portion 58 of the guide contour 55 connecting the longitudinal portions 56 are provided on opposite sides of the longitudinal portions 56. The connecting portion 58 is provided by a narrow side of the rear wall 45 of the base body 40.

The guide contour 55 therefore delimits a flow channel 52 which leads to the suction region 35 at the suction connection 31. The flow channel 52 thus runs past the machine guide surface 23 or next to the machine guide surface 23 or directly adjacent to the machine guide surface 23.

It is clear from FIG. 3 that the handheld power saw 10 can be guided directly on the workpiece W with the machine guide surface 23 when the suction device 30 is removed from the handheld power saw 10. However, if the suction device 30 is fastened to the handheld power saw 10, the guide contour 55 is used for guiding on the workpiece W.

The recess 47 for the sawing tool 15 is delimited on the peripheral side by an inner wall 48. The inner wall 48 extends to an end wall 49 which is arranged at the free end regions of the side legs 37.

A top wall 55 which lies diagonally opposite the bottom wall 43 extends between the side walls 44. Furthermore, a top wall 51 is connected to the top wall 50 on which the connecting piece 32 is arranged.

The top walls 50, 51 are preferably at an angle to one another, such that the connecting piece 32 arranged on the top wall 51 is oriented at an angle to the guide contour 55, for example at an angle of approximately 45°.

Consequently, a flow channel runs through the suction connection 31 obliquely to the rear in the direction of the machine housing 17 when the suction device 30 is fastened to the handheld power saw 10. It is preferred if the flow channel is inclined backwards with respect to the machine housing 17 and/or is oriented towards an underside of the machine housing 17.

Fastening means 60 are provided for fastening the suction device 30 to the handheld power saw 10, in particular to its guide device 20.

The fastening means 60 comprise a plug-in receptacle 61 and a plug-in receptacle 62 arranged next to the plug-in receptacle 61. The machine guide body 22 can be inserted into the plug-in receptacle 61 along a plug-in path SB1, namely with its edge part 24.

The plug-in receptacle 61 is bounded by the side walls 44 and the top wall 50, in particular a portion 50A of the top wall 50. In the plug-in receptacle 61 there is also a plug-in stop 54 which, for example, is connected to the side walls 44 and/or the top wall 50. The portion 50A of the top wall 50 is supported on the machine guide body 22, such that the suction device 30 is supported with respect to a force acting from below to the right in FIG. 6, for example, which can be exerted by the suction hose 95, for example.

The edge portion 24 of the machine guide body 22 strikes the plug-in stop 54 with its end face 24A facing away from the recess 26, which is shown by way of example in FIG. 5 and FIG. 6, for example. Consequently, the edge portion 24 of the machine guide body 22 forms a plug-in projection for plugging into the plug-in receptacle 61.

When the machine guide body 22 is plugged into the plug-in receptacle 61, it is then completely plugged into the plug-in receptacle 62 arranged next to the plug-in receptacle 61, namely along a plug-in path SB2. The plug-in path SB2 runs at an angle to the plug-in path SB1, for example approximately at right angles.

When the machine guide body 22 is inserted into the receptacles 61, 62, a part 24B of the machine guide body 22 assigned to the sawing tool 15 protrudes in front of the suction device, in particular the support leg 46.

While the plug-in path SB1 can have a substantially rectilinear or linear course, the plug-in path SB2 is, for example, approximately arcuate. Consequently, the machine guide body 22 is pivoted into the plug-in receptacle 62, so to speak, with the machine guide body 22 being pivoted with its edge portion 24 in the plug-in receptacle 61, which in this respect forms a pivot bearing receptacle.

When the machine guide body 22 is pivoted into the plug-in receptacle 62, it is supported on the side walls 44 with its narrow longitudinal sides, which extend next to the machine guide surface 23. Supporting ribs 53 for supporting the machine guide body 22 are preferably provided there.

The plug-in receptacles 61 and 62 form form-fitting receptacles 61A, 62A for holding the machine guide body 22 as a whole in a form-fitting manner. Consequently, for example, the two form-fitting receptacles 61A, 62A are form-fitting holding means 63.

Further form-fitting-latching holding means 63 of the fastening means 60 are formed by support bodies 64 and 65 which are provided for engaging in machine plug-in receptacles 28 on the machine guide body 22.

The machine plug-in receptacles 28 are located on the side legs 27 and are arranged directly on the machine guide surface 23. Consequently, recesses are provided on the machine guide surface 23 to provide the machine plug-in receptacles 28.

The support bodies 64, 65 form plug-in projections 64A, 65A for plugging into the machine plug-in receptacles 28. The machine plug-in receptacles 28 form form-fitting-latching receptacles and/or components of form-fitting means.

A support body 64 and a support body 65 are provided on each side leg 37. Both support bodies 64 and 65 of a respective side leg 37 engage in one and the same machine plug-in receptacle 28.

It would of course be possible for a separate plug-in receptacle to be provided on the side legs 27 of the machine guide body 22 for each support body 64 or 65, even if this is not shown in the drawing.

Latching projections 67 are provided between the support bodies 64 and 65 to provide latching means 66. The latching projections 67 have latching contours 68 on their free end regions, which are designed for latching with the machine plug-in receptacles 28, which form latching receptacles. The latching projections 67, which are designed, for example, as latching hooks 67A, hook into the plug-in receptacles 28 and are supported on the machine guide body 22 on a side facing away from the machine guide surface 23, i.e., on the edge regions of the machine plug-in receptacles 28. The latching projections 67 can be gripped by an operator, for example with his fingers, such that she can move the two latching projections 67 toward one another, i.e., in the direction of the recess 47, which is indicated as a release movement LK in the drawing, in order to disengage the latching projections 67 to bring engagement with the plug-in receptacles or latching receptacles 28.

The support bodies 64 have a stabilizing effect, i.e., they support the suction device 30 during the release actuation or release movement LK by preventing the side legs 37 on which the latching projections 67 are arranged from moving toward one another.

The support bodies 64 are provided on the longitudinal end regions of the side legs 37, for example as an extension of the end wall 49 or as an extension of the end wall 49.

Extending alongside the end wall 49 is the inner wall 48 which delimits the recess 47, the end wall 49 and the inner wall 48 being at an angle to one another. Due to the mutually angled walls 48 and 49, the support bodies 64, which are designed in the manner of spikes or supporting projections, are particularly rigid.

Thus, when the support bodies 64 engage in the machine plug-in receptacles 28, they support the side legs 37 of the suction device 30 with respect to movements in the sense of a narrowing of the recess 47 or a widening of the recess 47. Thus, the support bodies 64 can act in particular as a support during the release movement LK.

The machine plug-in receptacles 28, in which the latching projections 67 also engage, are designed, for example, as slots, such that the support bodies 64, 65 arranged next to one another in a row and the latching projections 67 arranged in between can engage in one and the same machine plug-in receptacle 28.

The support bodies 64 and the support bodies 65 are provided for support on mutually opposite longitudinal end regions of the machine plug-in receptacles 28. Both support bodies 64 and 65 counteract mutually opposite sliding movements of the machine guide body 22 along the plug-in path SB1.

The machine plug-in receptacles 28 and/or 29 are designed, for example, as passage openings. The machine plug-in receptacles 28 and 29 form latching receptacles, for example and/or form-fitting receptacles and/or plug-in receptacles, i.e., generally receptacles for the fastening means 60, 160, 260.

The support bodies 65 counteract a release movement or a pulling out of the machine guide body 22, in particular of the edge portion 24, from the plug-in receptacle 61 and form plug-fixing means 74 with respect to the plug-in receptacle 61.

At the bottom of the receptacle 62 and/or on the bottom wall 43 a projection 69 is arranged. The projection 69 can be provided for support on the machine guide surface 23, for example and/or as an aid for a tool, for example an injection molding tool, with which the suction device 30 can be produced. If there is no machine plug-in receptacle 29, as explained below which is arranged on a base leg of the machine guide surface 23, the projection 69 can be supported on the machine guide surface 23. An embodiment of the machine guide surface 23 or the machine guide body 22 without a machine plug-in receptacle 29 is preferred when the suction device 30 is used.

Additional plug-in fixing means 74 can also be formed by the projection 69, for example, if this forms a latching contour. The projection 69, i.e., the latching contour, can, for example, engage in a latching manner in the machine plug-in receptacle 29 forming a latching receptacle when the edge part 24 is inserted into the plug-in receptacle 61 along the plug-in path SB1.

The support bodies 64, 65 thus ensure that the edge portion 24 or the machine guide body 22 is held in a form-fitting manner in the plug-in receptacle 61.

The latching means 66, in particular the latching projections 67, counteract a release of the machine guide body 22 from the plug-in receptacle 62 along the plug-in path SB2 and form plug-fixing means 75 with respect to the plug-in receptacle 61.

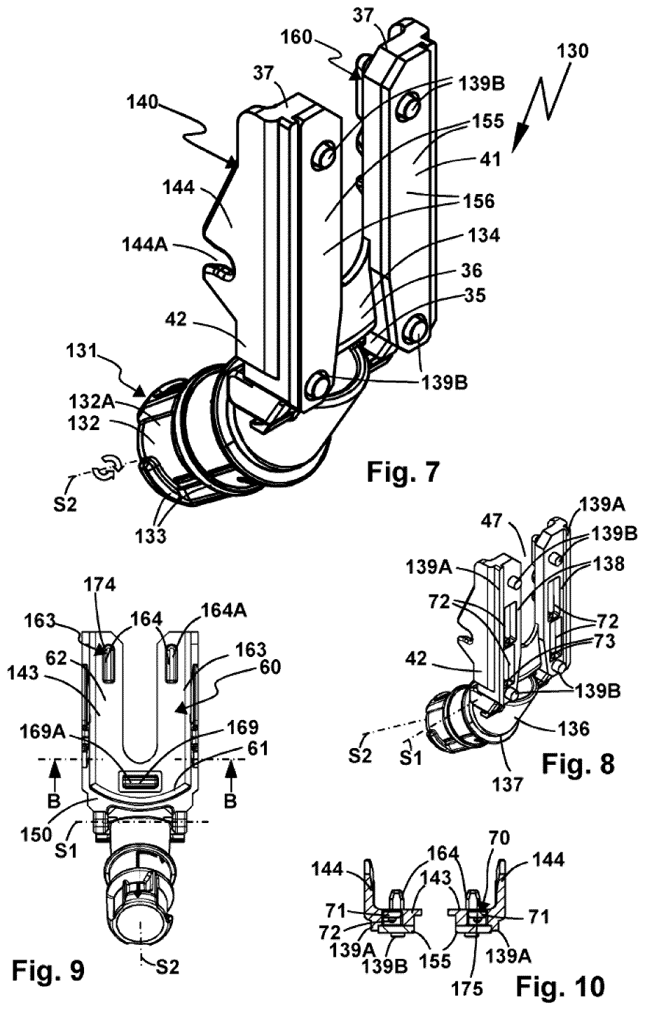

A suction device 130 according to FIGS. 7-10 has components that are similar or identical to those of the suction device 30.

The suction device 130 comprises a support portion 41 for support on the machine guide body 22 and a suction portion 42 with a suction connection 131. The suction connection 131 comprises a connecting piece 132 as a connection body 132A, on the outer circumference of which form-fitting contours 133, for example bayonet-like form-fitting contours 133, are arranged for connecting the connecting piece 94 or another connecting piece of a suction hose having bayonet contours.

A preferred concept provides that the connecting piece 132 can be rotated or pivoted about an axis S2 with respect to a base body 140 of the suction device 30. For this purpose, a tubular body 136, for example, is arranged on the base body 140, on which the connecting piece 132 is pivotally mounted, for example by means of a pivot bearing 137. The pivot bearing 137 is formed, for example, in that flange-like projections and receptacles of the connecting piece 132 and the tubular body 136 engage in one another. The tubular body 136 and the connecting piece 132 are flow-connected to one another.

The tubular body 136 has an inlet opening which is open to a suction region 35 between side legs 37 of the suction device 130 and is flow-connected thereto.

The base body 140 thus has the two side legs 37 and a base 36 from which the side legs 37 protrude.

The base body 140, like the base body 40, has plug-in receptacles 61 and 62 into which the machine guide body 22 can be inserted. Plug-in receptacles 61 and 62 and magnetic holding means 70 form part of fastening means 160 of suction device 130.

From a bottom wall 143 of the base body 140, which represents the base of the support part 41, so to speak, side walls 144 protrude at an angle in the manner of side legs, on which narrow sides of the machine guide body 22 can be supported. The side walls 144 and the bottom wall 143 delimit the plug-in receptacle 62.

The bottom wall 143 and a top wall 150 lying opposite it in the region of the suction connection 131 and portions of the side walls 144 delimit the plug-in receptacle 61.

Recesses 144A can be provided on the side walls 144, in which, for example, the connecting elements 27A or other contours protruding in front of the machine guide body 22 can engage.

As a result, the machine guide body 22 can be inserted into the plug-in receptacles 61 and 62 along the already explained plug-in paths SB1 and SB2, with plug-in fixing means 174 and 175 fixing the machine guide body 22 in the plug-in receptacles 61 and 62.

The plug-fixing means 174 include plug-in projections or support bodies 164 for engaging in the machine plug-in receptacles 28. The plug-in paths SB1 and SB2 run in plug-in directions SR1 and SR2 at an angle to one another.

Advantageously, the plug-fixing means 174 also include a plug-in projection 169, which can also be regarded as a latching projection, which is provided and designed to engage in the plug-in receptacle or latching receptacle 29. The plug-in projection or latching projection 169 is located, so to speak, on the base 36 in a bottom region of the plug-in receptacle 61. For example, the plug-in projection 169 is designed as a latching contour 169A and thus as a latching means.

The plug-in fixing means 175 comprise magnetic holding means 70. The magnetic holding means 70 comprise a plurality of magnets 71 for a magnetic hold on the machine guide body 22. The magnets 71 ensure that the suction device 130 is held magnetically on the machine guide body 22, for example if this is made of ferromagnetic metal. The suction device 30 must therefore be removed from the machine guide body 22 against the force of the magnets 71, such that it can be removed from the plug-in receptacle 62 when the suction device 30 is no longer required.

The magnets 71 are received in receptacles 72 of the base body 140. The receptacles 72 are arranged on the side legs 37, for example. A clamping contour 73, for example a clamping projection, is advantageously arranged in a respective receptacle 72 for clamping the magnet 71 received in the receptacle 72. The magnets 71 can, for example, be held in the receptacles 72 in a materially bonded manner, for example by gluing.

The receptacles 72 are provided, for example, on the bottom wall 43, in particular on the side facing away from the plug-in receptacle 62. The receptacles 72 are open, for example in the direction of a guide contour 155 of the suction device 130, but are closed by guide elements 156. Thus, the receptacles 72 and the magnets 71 arranged therein are covered both on their side facing away from the plug-in receptacle 62 and on their side facing the plug-in receptacle 62.

The guide elements 156 are made of plastic or metal, for example. The guide elements 156 preferably consist of a ferromagnetic multipart, such that the magnets 71 can also hold the guide elements 156 magnetically on the base body 140.

The base body 140 has receptacles 138 for the guide elements 156 on a side facing away from the plug-in receptacle 62. The guide elements 156 are designed, for example, like plates and have recesses into which the retaining projections 139B on the receptacles 138 engage. The holding projections 139B are designed, for example, in the form of supporting projections, latching projections or the like. Furthermore, the receptacles 138 are bounded by side legs 139A which project at an angle from the bottom wall 143.

The guide elements 156 are advantageously designed in the form of guide skids or the like, with which the suction device 130 and thus also the handheld power saw 10 to which the suction device 130 is fastened can be guided along the workpiece W.

The guide elements 156 extend along the side legs 37 and are arranged laterally next to the recess 47 into which the sawing tool 15 can engage.

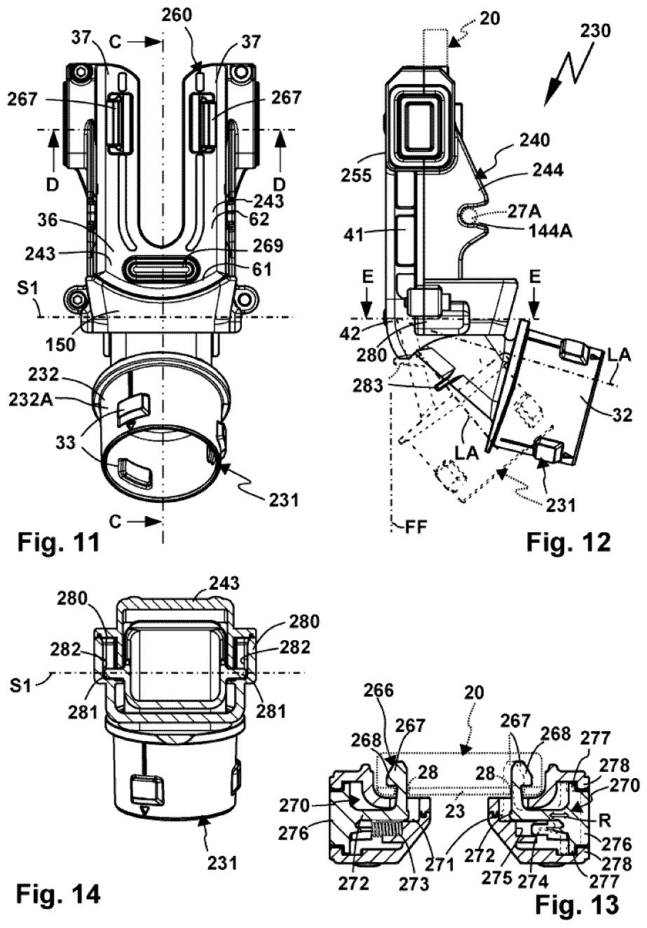

A further pivotability of the connecting piece 132 or the suction connection 131 with respect to the base body 140 about a pivot axis S1 is indicated in FIG. 8 as an example, the pivot axes S1 and S2 being at an angle to one another, for example at right angles. A bearing concept for pivoting the connecting piece 132 about the pivoting axis S1 in addition to or alternatively to the pivoting about the pivoting axis S2 is explained in connection with the suction device 230 and its connecting piece 232 according to FIGS. 11-13.

At this point it should be mentioned that the bearing concept of the connecting piece 232 forming a connecting body 232A and the connecting piece 132 can also be implemented individually or in combination with the suction device 130.

The connecting piece 232 is pivotably mounted about the pivot axis S1 with respect to a base body 240 of the suction device 230 by means of pivot bearings 280.

Bearing receptacles 282 are arranged on the base body 240, in particular in the region of a plug-in receptacle 61 of the base body 240, into which bearing pins or bearing projections 281, which are arranged on the connecting piece 232, engage. The bearing projections 281 protrude outwards in front of the connecting piece 232 and engage in the bearing receptacles 282, which are configured as receiving chambers, for example.

Furthermore, a swivel stop 283 is provided on the connecting piece 232, which limits the swiveling movement of the connecting piece in the direction of a position aligned with a guide contour 255 of the suction device 230. For example, the swivel stop 283 is formed by a flange projection that strikes an outer peripheral surface of the base body 240.

The base body 240 essentially corresponds to the base bodies 40, 140 and has, for example, the plug-in receptacle 61 and a further plug-in receptacle 62 delimited by the side legs 244 that are functionally identical to side legs 44, 144.

A latching contour 269 for engaging in the plug-in receptacle or latching receptacle 29 of the machine guide body 22 is provided on the bottom of the plug-in receptacle 62, for example.

Furthermore, latching means 266 are provided, which are designed functionally similarly to latching means 66, but have latching projections 267 and can be operated easily using actuating portions 276.

The plug-in receptacles 61, 62 and the latching means 266 form fastening means 260 and/or form-fitting latching means 263 of the suction device 230.

The latching projections 267 have latching contours 268, for example hook contours, on their free end regions provided for engagement in the latching receptacles or machine plug-in receptacles 28. The hook contours or latching contours 268 can be disengaged and engaged with the plug-in receptacles or latching receptacles 28 by a displacement movement R (FIG. 13).

The latching projections 267 have bearing portions 272 which are displaceably mounted with respect to the movement R in bearing receptacles 271 of slide bearings 270. The bearing receptacles 271 are located, for example, on or in the region of the bottom wall 243 of the base body 240.

The latching projections 267 are biased by springs 273 in the direction of their latching position. Only one spring is shown in FIG. 13, with the latching projection 267 also having such a spring in the drawing on the right. The springs 273 rest on support projections 274 of the bearing portions 272 or the latching projections 267 and on a support surface 275 of the bearing receptacle 271. The support surfaces 275 limit the release movement of the latching projections 267 and opposite stops 278 of the bearing receptacles 271 limit the movement of the latching projections 267 in the direction of their latching position. Stops 277 of the latching projections 267 strike against the stops 278 and protrude in front of the actuating portions 276, for example.

The actuating portions 276 have actuating surfaces which are arranged on the outer sides of the side legs 244 of the base body 240. Thus, an operator can easily actuate the actuating surfaces with a kind of pinching movement of his fingers on one another in order to disengage the latching projections 267 from the latching receptacles or machine plug-in receptacles 28.

The guide contour 55 lies in a guide plane FF or spans a guide plane FF in the region of the sawing tool 15, for example in the region of the recess 47 when the suction device 30, 130, 230 is fastened to the machine guide body 22. The guide plane FF is that plane on which the suction device 30, 130, 230 is supported on the workpiece W in the region of the sawing tool 15. In principle, it is now possible for a longitudinal axis LA of the connection body 32A, 132A, 232A to run parallel to the guide plane FF. However, an angle WI between the longitudinal axis LA and the guide plane FF is preferred, for example a fixed angle in a range from 15° to 80°. Thus, the suction hose 91 can run obliquely away from the suction device 30, 130, 230 past the machine housing 17A. However, the angle WI can also be variable, for example using a pivot bearing arrangement. Such a pivotability or change in the position of the longitudinal axis LA with respect to the guide plane FF is shown in FIG. 12 as an example, which is implemented using the pivot bearing 280.

1. A handheld reciprocating saber saw with a suction device, wherein the handheld reciprocating saber saw has a machine housing, wherein a drive motor is arranged within the machine housing, and the reciprocating saber saw has a tool holder which can be driven by the drive motor in a linearly oscillating manner along an axis of movement, wherein the tool holder is for a sawing tool having an elongate design, and the sawing tool extending along a longitudinal axis for making a saw cut in a workpiece, wherein the handheld reciprocating saber saw has a machine guide body, the machine guide body having a machine guide surface facing away from the machine housing, wherein the sawing tool protrudes in front of the machine guide surface when mounted on the handheld reciprocating saber saw, the machine guide surface for guiding the handheld reciprocating saber saw on the workpiece, and
wherein the suction device has fastening means for detachable fastening on the handheld reciprocating saber saw and has a suction connection for connecting a suction hose such that particles produced when the workpiece is being machined can be suctioned away from the machine guide body through the suction connection, and wherein the suction device has at least one guide contour which, when the suction device is mounted on the handheld reciprocating saber saw, protrudes in front of the machine guide surface such that the handheld reciprocating saber saw can be guided on the workpiece instead of the machine guide surface by means of the at least one guide contour, and
wherein the sawing tool passes through the machine housing along the longitudinal axis.

2. The handheld reciprocating saber saw and the suction device of claim 1, further comprising a support part for support on the machine guide surface.

3. The handheld reciprocating saber saw and the suction device of claim 1, wherein the machine housing has a longitudinal main housing part and a handle, the longitudinal main housing part containing the drive motor and extending along the longitudinal axis, and the handle extending away from the main housing part at an angle with respect to the longitudinal axis.

4. The handheld reciprocating saber saw and the suction device of claim 1, wherein the support part is designed to receive part of the machine guide surface in such a way that another part of the machine guide surface protrudes in front of the suction device.

5. The handheld reciprocating saber saw and the suction device of claim 1, wherein the suction device has at least one side wall, the narrow side or front side of which forms the guide contour or a component of the guide contour.

6. The handheld reciprocating saber saw and the suction device of claim 1, further comprising at least two side walls at a distance from one another, the distance being designed and provided to receive the sawing tool and/or forms part of a flow channel leading to the suction connection.

7. The handheld reciprocating saber saw and the suction device of claim 1, wherein at least part of the guide contour is arranged on a guide element which is detachably fastened or fastenable to a base body of the suction device.

8. The handheld reciprocating saber saw and the suction device of claim 1, wherein the suction connection has a connecting piece which is designed for connecting a suction hose and which is rotatably mounted with respect to a base body of the suction device, which basic body is provided and designed for connection to the machine guide body.

9. The handheld reciprocating saber saw and the suction device of claim 1, wherein the guide contour spans a guide plane or lies in a guide plane in a region provided for the sawing tool, and wherein a longitudinal axis of the suction connection extends at an angle with respect to the guide plane.

10. The handheld reciprocating saber saw and the suction device of claim 9, wherein the angle is between 15° and 85°.

11. The handheld reciprocating saber saw and the suction device of claim 1, wherein the suction connection is pivotably mounted about at least one pivot axis by means of at least one pivot bearing with respect to a base body having the guide contour.

12. The handheld reciprocating saber saw and the suction device of claim 1, wherein the machine guide body is adjustably mounted on the machine housing by means of a bearing device, such that the machine guide surface can be adjusted between at least two mutually different relative positions in relation to the longitudinal axis with respect to the machine housing.

13. The handheld reciprocating saber saw and the suction device of claim 12, wherein the machine housing is arranged behind the suction device along the longitudinal axis.

14. The handheld reciprocating saber saw and the suction device of claim 1, wherein the drive motor is coaxial to the sawing tool and/or the tool holder.

15. A handheld reciprocating saber saw with a suction device, wherein the handheld reciprocating saber saw has a machine housing, wherein a drive motor is arranged within the machine housing, and the reciprocating saber saw has a tool holder which can be driven by the drive motor in a linearly oscillating manner along an axis of movement, wherein the tool holder is for a sawing tool having an elongate design, and the sawing tool extending along a longitudinal axis for making a saw cut in a workpiece, wherein the handheld reciprocating saber saw has a machine guide body, the machine guide body having a machine guide surface facing away from the machine housing, wherein the sawing tool protrudes in front of the machine guide surface when mounted on the handheld reciprocating saber saw, the machine guide surface for guiding the handheld reciprocating saber saw on the workpiece, and
wherein the suction device has fastening means for detachable fastening on the handheld reciprocating saber saw and has a suction connection for connecting a suction hose such that particles produced when the workpiece is being machined can be suctioned away from the machine guide body through the suction connection, and wherein the suction device has at least one guide contour which, when the suction device is mounted on the handheld reciprocating saber saw, protrudes in front of the machine guide surface such that the handheld reciprocating saber saw can be guided on the workpiece instead of the machine guide surface by means of the at least one guide contour, and
wherein the guide contour spans a guide plane or lies in a guide plane in a region provided for the sawing tool, and wherein a longitudinal axis of the suction connection extends at an angle between 30° and 80° with respect to the guide plane.

16. The handheld reciprocating saber saw and the suction device of claim 15, wherein the machine housing has a longitudinal main housing part and a handle, the longitudinal main housing part containing the drive motor and extending along the longitudinal axis, and the handle extending away from the main housing part at an angle with respect to the longitudinal axis, and
wherein the sawing tool passes through the machine housing along the longitudinal axis.

17. The handheld reciprocating saber saw and the suction device of claim 15, wherein the drive motor is coaxial to the sawing tool and/or the tool holder.

18. A handheld reciprocating saber saw with a suction device, wherein the handheld reciprocating saber saw has a machine housing, wherein a drive motor is arranged within the machine housing, and the reciprocating saber saw has a tool holder which can be driven by the drive motor in a linearly oscillating manner along an axis of movement, wherein the tool holder is for a sawing tool having an elongate design, and the sawing tool extending along a longitudinal axis for making a saw cut in a workpiece, wherein the handheld reciprocating saber saw has a machine guide body, the machine guide body having a machine guide surface facing away from the machine housing, wherein the sawing tool protrudes in front of the machine guide surface when mounted on the handheld reciprocating saber saw, the machine guide surface for guiding the handheld reciprocating saber saw on the workpiece, and
wherein the suction device has fastening means for detachable fastening on the handheld reciprocating saber saw and has a suction connection for connecting a suction hose such that particles produced when the workpiece is being machined can be suctioned away from the machine guide body through the suction connection, and wherein the suction device has at least one U-shaped guide contour which, when the suction device is mounted on the handheld reciprocating saber saw, protrudes in front of the machine guide surface such that the handheld reciprocating saber saw can be guided on the workpiece instead of the machine guide surface by means of the at least one guide contour.

19. The handheld reciprocating saber saw and the suction device of claim 18, wherein the machine housing has a longitudinal main housing part and a handle, the longitudinal main housing part containing the drive motor and extending along the longitudinal axis, and the handle extending away from the main housing part at an angle with respect to the longitudinal axis, and
wherein the sawing tool passes through the machine housing along the longitudinal axis.

20. The handheld reciprocating saber saw and the suction device of claim 18, wherein the drive motor is coaxial to the sawing tool and/or the tool holder.
